(19) United States
(12) Patent Application Publication
(10) Pub. No.: US 2011/0228155 A1
(43) Pub. Date: Sep. 22, 2011

(54) COSMETIC MIRROR AND ADJUSTING METHOD FOR THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/821,333

(22) Filed: Jun. 23, 2010

(30) Foreign Application Priority Data
Mar. 19, 2010 (TW) 99108087

(51) Int. Cl. H04N 5/222; G06K 9/00

(52) U.S. Cl. 348/333.01; 345/173; 382/103; 348/E05.022

(57) ABSTRACT

A cosmetic mirror includes a mirror, a camera, a touch screen, and a processing unit. The mirror reflects a first image of a user. The camera captures a second image of the user. The processing unit detects the second image to locate a face region in the second image, and transmits a third image of the face region of the user to the touch screen. The touch screen displays the third image. The processing unit further controls the camera and the touch screen according to operations applied on the touch screen.

### BACKGROUND

1. Technical Field

The present disclosure relates to a cosmetic mirror and an adjusting method for the cosmetic mirror.

2. Description of Related Art

People usually use glass mirrors for applying make-up. To make sure the make-up is applied correctly, a person must look at the mirror very closely. Because they are too close to the mirror, it is difficult to adjust the details of the applied make-up or to apply make-up easily for some areas on their face.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a first embodiment of a cosmetic mirror.

FIG. 2 is a block diagram of the cosmetic mirror of FIG. 2 with a storage unit.

FIG. 3 is a block diagram of the storage unit of FIG. 2.

FIGS. 4A-4D are schematic diagrams of the cosmetic mirror of FIG. 1 in use.

FIG. 5 is a schematic diagram of a second embodiment of a cosmetic mirror.

FIG. 6 is a schematic diagram of the cosmetic mirror of FIG. 5 in use.

FIG. 7 is a flowchart of an exemplary embodiment of an adjusting method for a cosmetic mirror.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

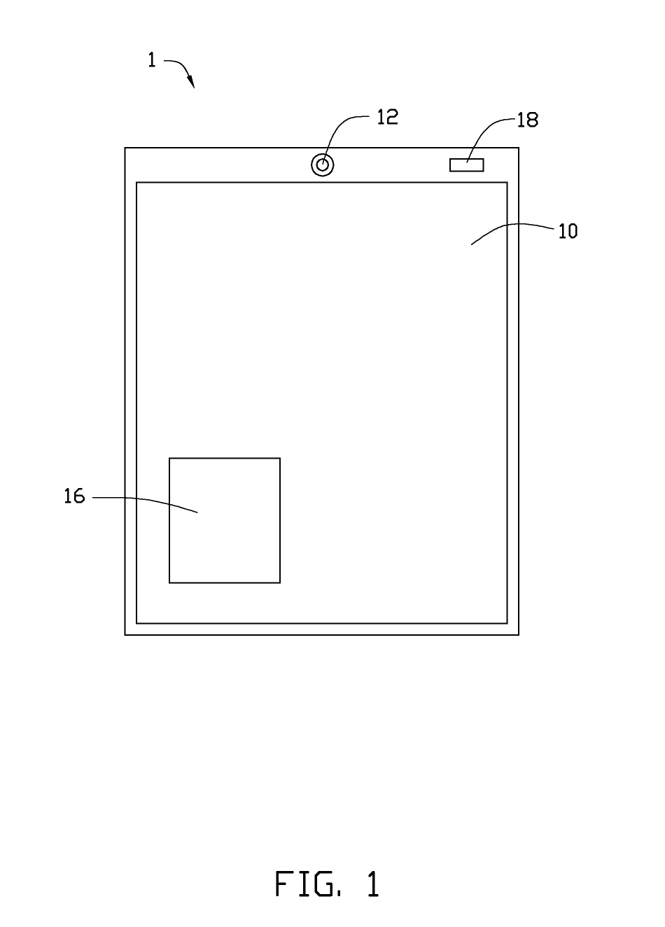

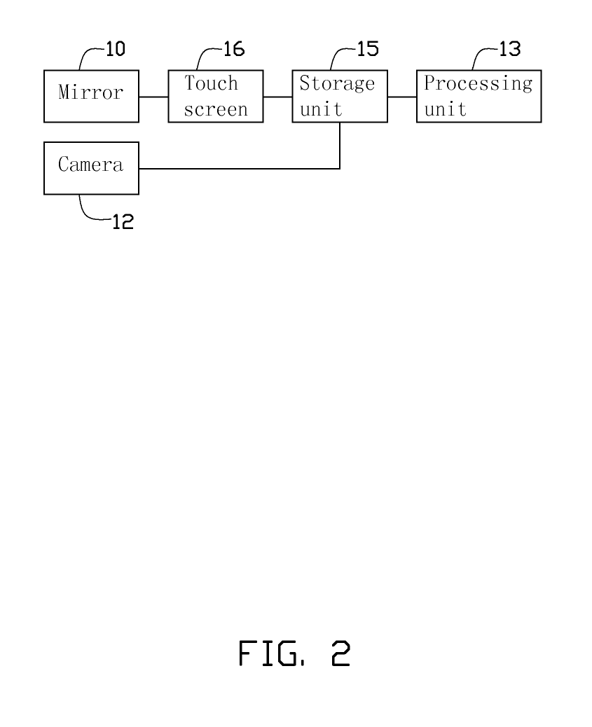

Referring to FIGS. 1 and 2, a first embodiment of a cosmetic mirror 1 includes a mirror 10, a camera 12, a storage unit 15, a processing unit 13, a touch screen 16, and a lamp 18.

The mirror 10 is an ordinary glass mirror for reflecting an image of an object in front of the mirror 10.

The camera 12 is mounted on a top side of the mirror 10 to capture an image. The processing unit 13 and the storage unit 15 process the image to locate a face region in the image, and control the camera 12 to shoot the face of the user to obtain a close-up image of the face.

The touch screen 16 is mounted on the mirror 10 to display the close-up image. In addition, the user can operate the touch screen 16 to control the camera 12 or change what the touch screen 16 displays.

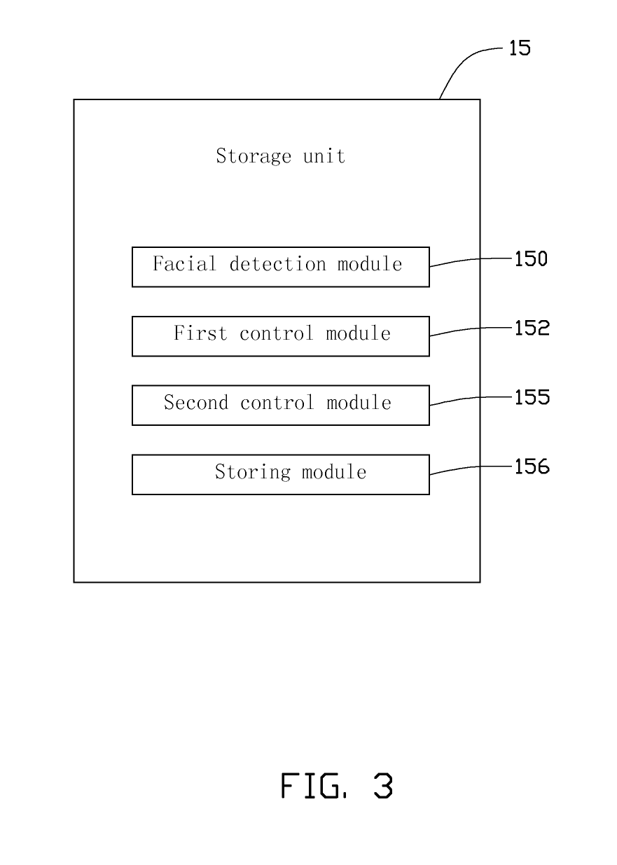

Referring to FIG. 3, the storage system 15 includes a facial detection module 150, a first control module 152 and a second control module 155, which may include one or more computerized instructions that are executed by the processing unit 13, and a storing module 156.

The facial detecting module 150 locates a face in the image from the camera 12. It is noteworthy that the facial detecting module 150 uses well known facial recognition technology to locate the face in the image.

After the facial detecting module 150 locates the face in the image, the first control module 152 outputs a control signal to the camera 12 to control the camera 12 to zoom in on the face of the user. As a result, a close-up image of the face of the user is obtained.

The touch screen 16 displays the close-up image. The touch screen 16 may be a resistive touch screen or a capacitive touch screen. In addition, the touch screen 16 further displays a plurality of orientation buttons and a plurality of buttons, such as a “play” button and a “capture” button. When one of the orientation buttons on the touch screen 16 is operated, the first control module 152 controls the camera 12, according to the operated orientation button. When the “capture” button on the touch screen 16 is operated, the first control module 152 controls the camera 12 to capture an image of the user.

When one of the orientation buttons is operated, the touch screen 16 outputs a corresponding sensed signal to the first control module 152. The first control module 152 outputs a control signal to the camera 12 to control the camera 12. When the “play” button is operated, the touch screen 16 outputs a corresponding sensed signal to the second control module 155. The second control module 155 controls the touch screen 16 to play, such as a tutorial stored in the storing module 156.

The lamp 18 may be used in a dark or gloomy environment.

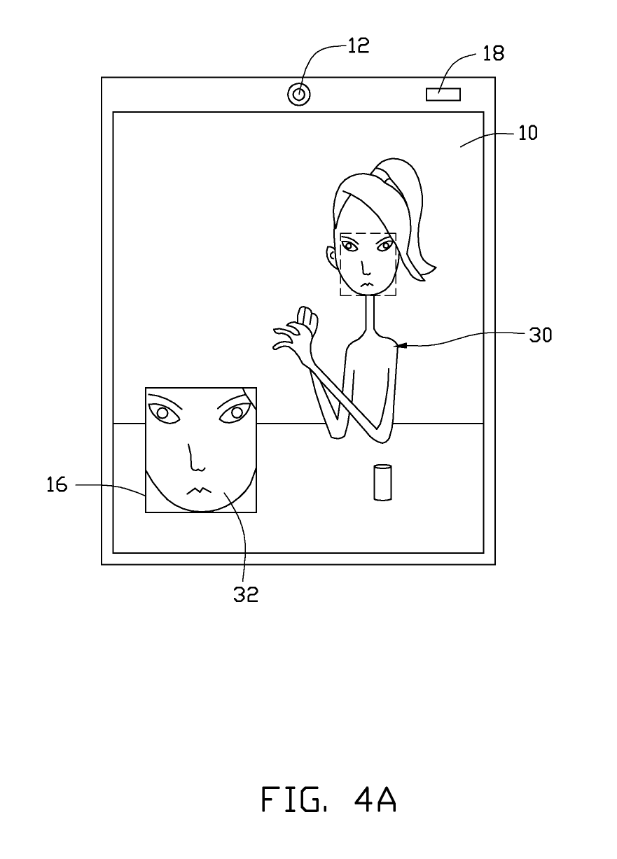

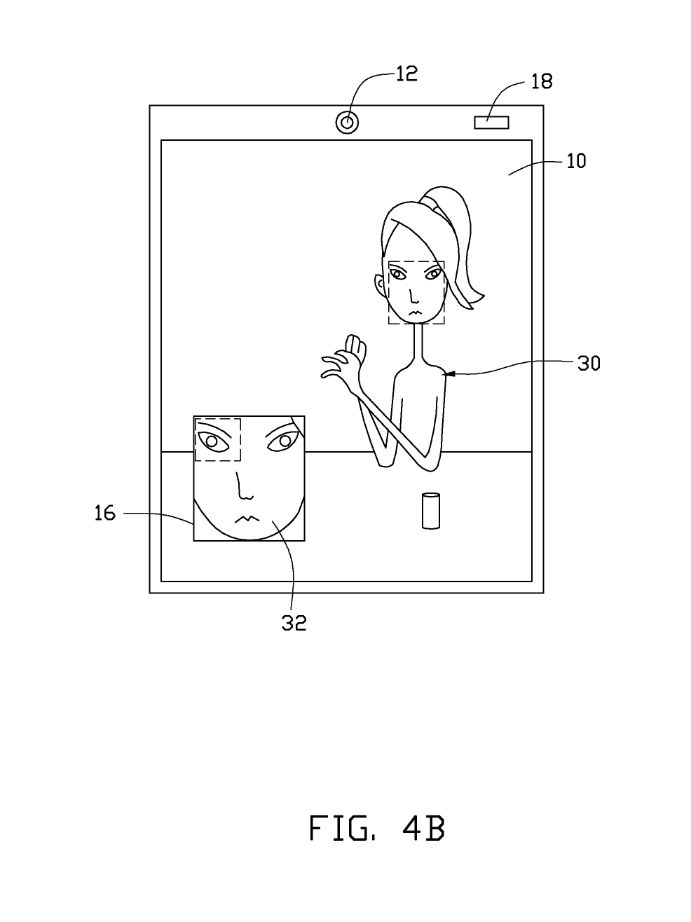

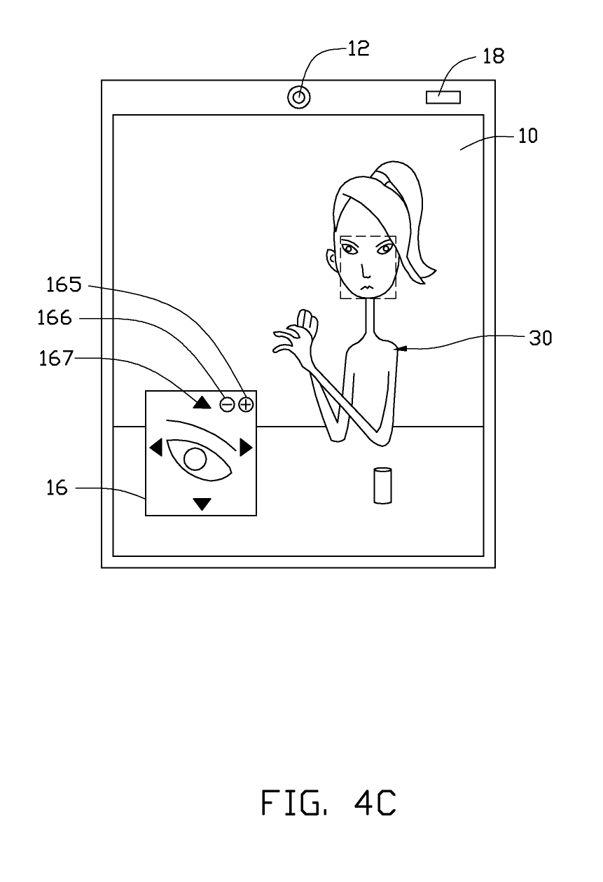

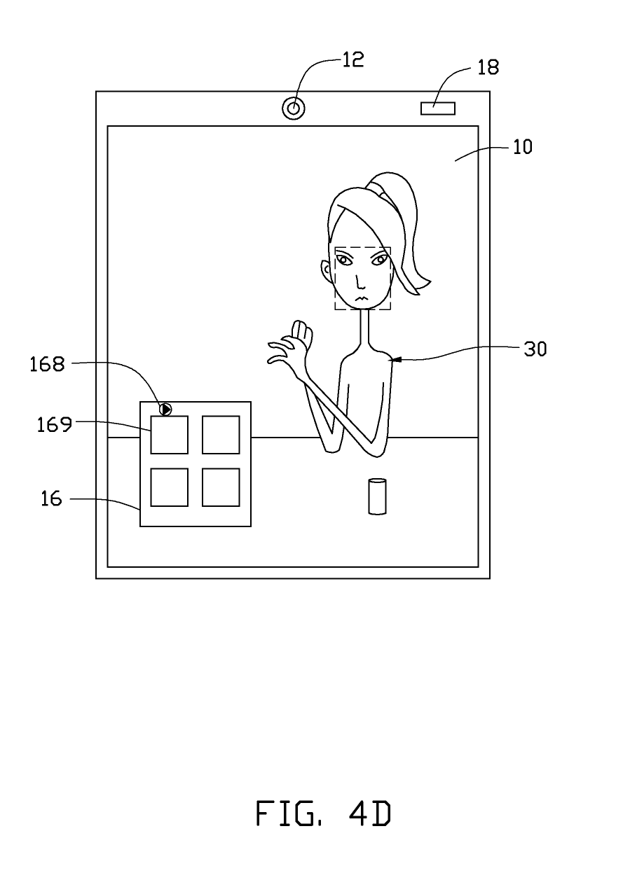

Referring to FIG. 4A, a first image 30 is displayed in the mirror 10. The camera 12 captures a second image of the user. The facial detecting module 150 detects the second image to locate a face. The first control module 152 controls the camera 12 for obtaining a close-up image 32 of the located face. The close-up image 32 is displayed on the touch screen 16.

Referring to FIG. 4B, when the user selects an eye region in the close-up image 32 on the touch screen 16, the touch screen 16 transmits a corresponding sensing signal to the second control module 155. The second control module 155 magnifies the selected region, and displays the selected region on the touch screen 16 as shown in FIG. 4C.

Referring to FIG. 4C, when the selected region is displayed on the touch screen 16, the touch screen 16 further displays a plurality of buttons, such as a zoom in button 165, a zoom out button 166, and four orientation buttons 167. When one of the buttons is operated, the second control module 155 outputs a corresponding signal to control the touch screen 16. For example, when the zoom in button 165 is operated, the second control module 155 controls the touch screen 16 to display a magnified image.

Referring to FIG. 4D, when the play button 168 on the touch screen 16 is operated, a plurality of icons 169 for a plurality of videos are displayed on the touch screen 16. The plurality of videos are stored in the storing module 156. When one of the icons 169 is operated, a video corresponding to the icon 169 is played on the touch screen 16. In the embodiment, the videos stored in the storing module 156 may be used to tutor the user with make-up application skills.

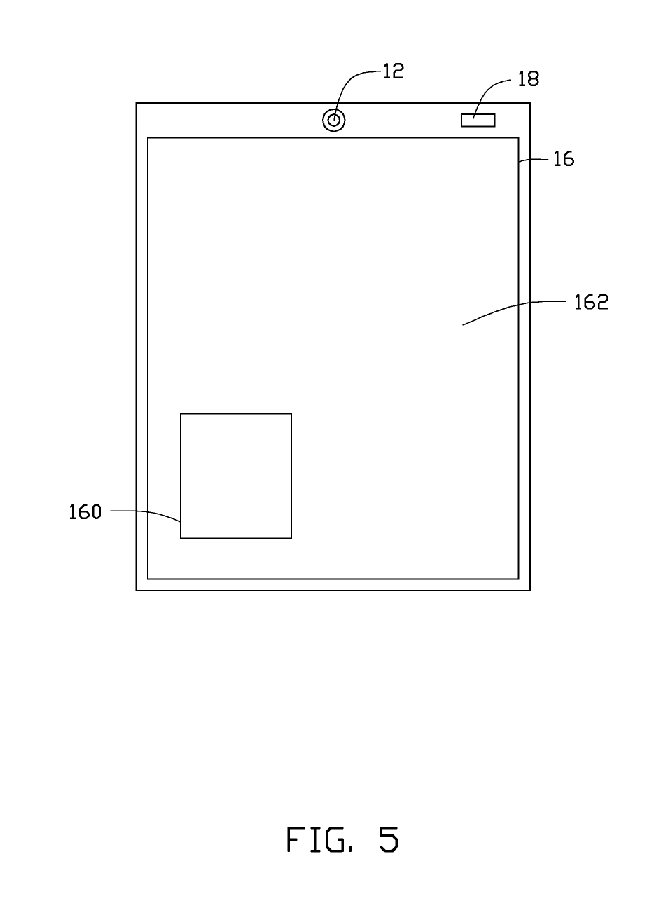

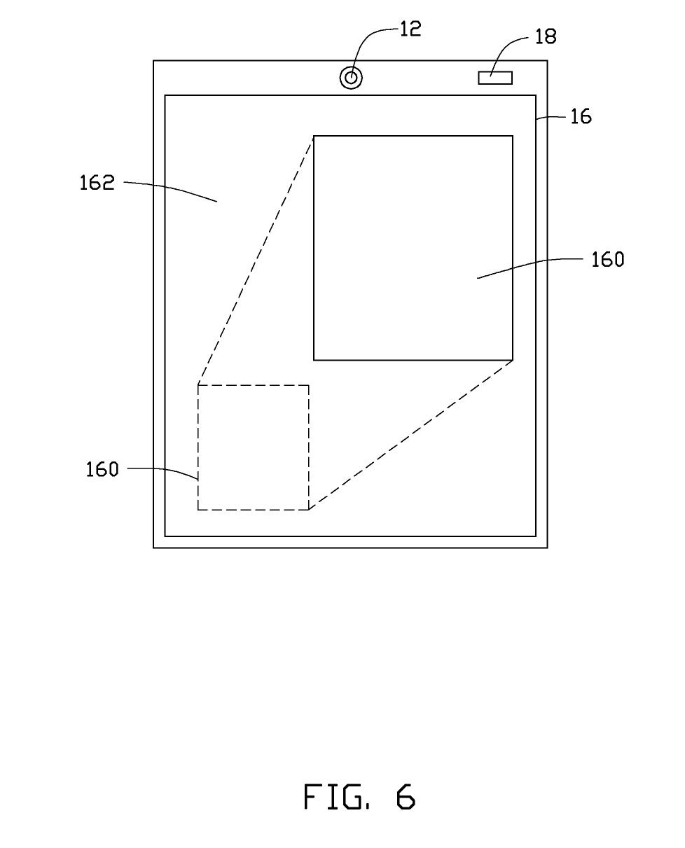

Referring to FIG. 5, in a second embodiment, a touch screen 26 replaces the mirror 10 in the first embodiment. The camera 12 captures the image of the user. The image is displayed on a first region 262 of the touch screen 26, and is transmitted to the facial detecting module 150. The facial detecting module 150 detects the image to locate a face region in the image. The face region in the image is displayed on a second region 260 of the touch screen 26. In addition, as shown in FIG. 6, the second region 260 can be manipulated to have a larger size or a smaller size according to need.

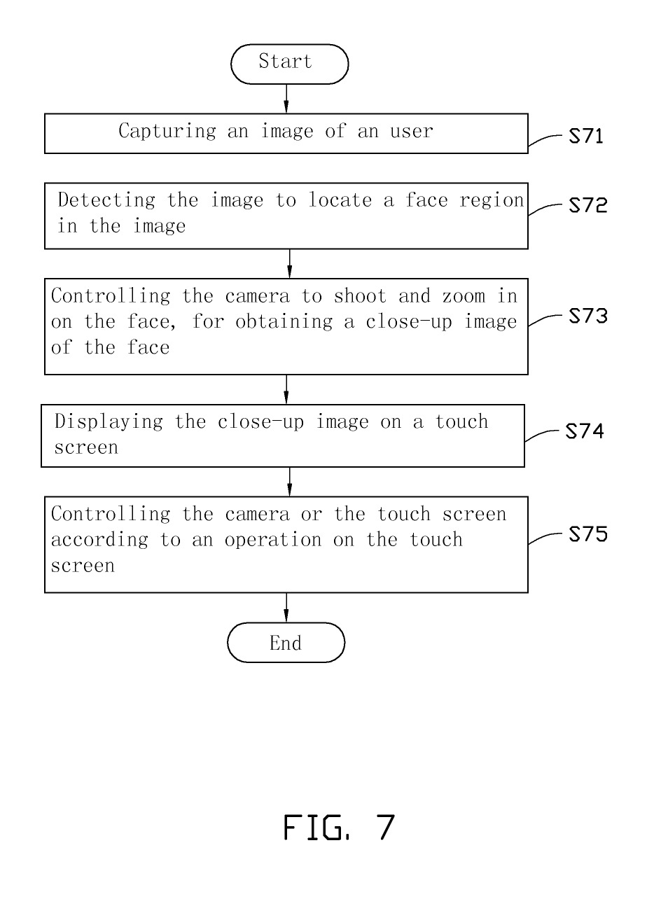

Referring to FIG. 7, an exemplary embodiment of an adjusting method for the cosmetic mirror includes the following steps.

In step S71, the camera 10 captures an image of the user.

In step S72, the facial detecting module 150 detects the image to locate a face region in the image.

In step S73, the first control module 152 controls the camera 10 to shoot and zoom in on the face, for obtaining a close-up image of the face.

In step S74, the touch screen 16 displays the close-up image.

In step S75, the touch screen 16 transmits a sensed signal corresponding to an operation on the touch screen 16 to the first control module 152 or the second control module 155 for controlling the camera 10 or the touch screen 16.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A cosmetic mirror comprising:
a mirror to reflect a first image of an user;
a camera to capture a second image of the user;
a touch screen;
a processing unit; and
a storage unit connected to the processing unit and the touch screen, and storing a plurality of programs to be executed by the processing unit, wherein the storage unit comprises:
a facial detecting module to detect the second image to locate a face region in the second image;
a first control module to control the camera to shoot a face region of the user, and transmit a third image of the face region of the user to the touch screen, and to control the camera according to operations applied on the touch screen; and
a second control module to control the touch screen according to an operation on the touch screen.

2. The cosmetic mirror of claim 1, wherein when one of a plurality of orientation buttons on the touch screen is operated, the first control module controls the camera according to the operated orientation button.

3. The cosmetic mirror of claim 1, wherein when a capture button on the touch screen is operated, the first control module controls the camera to capture an image of the user.

4. The cosmetic mirror of claim 1, wherein the storage unit further comprises a storing module for storing a plurality of videos, when one icon on the touch screen corresponding to one of the videos is operated, the corresponding video is displayed on the touch screen.

5. An adjusting method for a cosmetic mirror, the adjusting method comprising:
capturing a first image of an user by a camera;
detecting the first image to locate a face region in the first image;
controlling the camera to shoot a face region of the user to obtain a second image of the face region of the user;
displaying the second image of the user on a touch screen; and
controlling the camera or the touch screen according to operations applied on the touch screen.

6. The adjusting method of claim 5, wherein the step of “controlling the camera or the touch screen according to operations applied on the touch screen” comprises:
controlling the camera to turn around according to an operated orientation button upon the condition that one of a plurality of orientation buttons on the touch screen is operated.

7. The adjusting method of claim 5, wherein the step of “controlling the camera or the touch screen according to operations applied on the touch screen” comprises:
controlling the camera to capture an image of the user upon the condition that a capture button on the touch screen is operated.

8. The adjusting method of claim 5, wherein the step of “controlling the camera or the touch screen according to operations applied on the touch screen” comprises:
displaying a corresponding video on the touch screen upon the condition that an icon on the touch screen corresponding to one of a plurality of videos is operated.

9. A cosmetic mirror comprising:
a camera to capture a first image of an user;
a touch screen comprising a first region and a second region, wherein the first region of the touch screen displays the first image of the user;
a processing unit; and
a storage unit connected to the processing unit and the touch screen, and storing a plurality of programs to be executed by the processing unit, wherein the storage unit comprises:
a facial detecting module to detect the first image to locate a face region in the first image;
a first control module to obtain a second image of the face region in the first image, and transmit the second image to the touch screen, wherein the second region of the touch screen displays the second image, the first control module further controls the camera according to operations applied on the touch screen; and
a second control module to control the touch screen according to an operation applied on the touch screen.

10. The cosmetic mirror of claim 9, wherein when a capture button on the touch screen is operated, the first control module controls the camera to capture an image of the user.

11. The cosmetic mirror of claim 9, wherein the storage unit further comprises a storing module for storing a plurality of videos, when one icon on the touch screen corresponding to one of the plurality of videos is operated, the corresponding video is displayed on the touch screen.
